(19) United States
(12) Patent Application Publication
(10) Pub. No.: US 2013/0094457 A1
(43) Pub. Date: Apr. 18, 2013

(54) DATA TRANSMISSION AND RECEPTION METHOD OF MACHINE TYPE COMMUNICATION (MTC) DEVICE

(71) Applicant: Electronics and Telecommunications Research In, Daejeon (KR)

(72) Inventors: Bang Won SEO, Daejeon (KR); Young Jo KO, Daejeon (KR); Tae Gyun NOH, Daejeon (KR)

(73) Assignee: Electronics and Telecommunications Research Institute, Daejeon (KR)

(21) Appl. No.: 13/650,583

(22) Filed: Oct. 12, 2012

(30) Foreign Application Priority Data
Oct. 14, 2011 (KR) 10-2011-0105280
Oct. 25, 2011 (KR) 10-2011-0109444
Jan. 6, 2012 (KR) 10-2012-0001953
Sep. 24, 2012 (KR) 10-2012-0105680

(51) Int. Cl. H04W 72/04

(52) U.S. Cl. 370/329

(57) ABSTRACT

There are provided a data transmission and reception method of a machine type communication (MTC) device, and an MTC device using the same. The data transmission and reception method of the MTC device includes: extracting information related to an MTC band from a downlink frame received from a base station, searching for an MTC downlink resource region in the downlink frame based on the information related to the MTC band, and extracting MTC data for the corresponding MTC device from the MTC downlink resource region. The MTC band includes a band through which at least a physical broadcast channel and a synchronization channel are transmitted.

### CLAIM FOR PRIORITY

This application claims priority to Korean Patent Applications No. 10-2011-0105280 filed on Oct. 14, 2011, No. 10-2011-0109444 filed on Oct. 25, 2011, No. 10-2012-0001953 filed on Jan. 6, 2012, and No. 10-2012-0105680 filed on Sep. 24, 2012 in the Korean Intellectual Property Office (KIPO), the entire contents of which are hereby incorporated by reference.

### BACKGROUND

1. Technical Field

An example embodiment of the present invention relates in general to a data transmission and reception method of a machine type communication (MTC) device, and more specifically, to a machine type communication (MTC) device, and an apparatus and method for downlink data transmission.

2. Related Art

Machine type communication (MTC) or machine-to-machine (M2M) communication is a form of data communication which involves one or more entities that do not necessarily need human interaction. Service optimized for MTC differs from service optimized for human-to-human communication. In comparison with current mobile network communication service, MTC service can be characterized by a) several market scenarios, b) data communication, c) lower cost and less effort, d) a potentially very large number of communicating terminals, e) a wide service area, and f) very small traffic per terminal.

MTC may appear in various service forms. An MTC scheme is a primary issue in the fields of Smart Metering, Tracking & Tracing, Remote Maintenance & Control, eHealth, etc.

Lately, 3^{rd} Generation Partnership Project (3GPP) has been working on MTC standardization for intelligent communication between humans and objects and between objects. However, details on a frame structure for MTC have not yet been proposed.

### SUMMARY

Accordingly, example embodiments of the present invention are provided to substantially obviate one or more problems due to limitations and disadvantages of the related art.

An example embodiment of the present invention provides a data transmission and reception method of a machine type communication (MTC) device.

Another example embodiment of the present invention also provides a downlink data transmission method.

Another example embodiment of the present invention also provides an MTC device.

Another example embodiment of the present invention also provides a downlink data transmission apparatus.

In an example embodiment, there is provided a data transmission and reception method of a machine type communication (MTC) device, including: extracting information related to an MTC band from a downlink frame received from a base station; searching for an MTC downlink resource region in the downlink frame based on the information related to the MTC band; and extracting MTC data for the corresponding MTC device from the MTC downlink resource region.

The MTC band may include a band through which at least a physical broadcast channel and a synchronization channel are transmitted.

The information related to the MTC band may include at least one piece of information among information about an MTC downlink bandwidth, information about the location of an MTC downlink band, information about an MTC downlink control channel, and information about an MTC downlink data channel.

The MTC downlink resource region may include an MTC downlink control channel and an MTC downlink data channel.

The MTC downlink resource region may include at least one piece of information of information about the number of symbols occupied by the MTC downlink control channel, and information about an MTC retransmission indicator.

The MTC band may include at least one resource block located at a central part of a system bandwidth.

In another example embodiment, there is provided a data transmission and reception method of a machine type communication (MTC) device, including: extracting information related to an MTC uplink band from a downlink frame received from a base station; configuring an uplink frame including an MTC uplink resource region based on the information related to the MTC uplink band; and transmitting the uplink frame to the base station.

The MTC uplink band may include at least one resource block located at a central part of an uplink system bandwidth.

The information related to the MTC uplink band may include at least one piece of information among information about an MTC uplink bandwidth, information about the location of an MTC uplink band, information about an MTC uplink control channel, and information about an MTC uplink data channel.

The MTC uplink bandwidth may be the same as or narrower than an uplink system bandwidth.

In another example embodiment, there is provided a downlink data transmission method including: configuring a downlink frame including information related to a machine type communication (MTC) downlink band, and information related to an MTC uplink band; and transmitting the downlink frame to at least one MTC device.

The MTC downlink band includes a band through which at least a physical broadcast channel and a synchronization signal are transmitted.

In another example embodiment, there is provided a machine type communication (MTC) device including: a receiver configured to receive a downlink frame from a base station; and a controller configured to extract information related to an MTC downlink band and information related to an MTC uplink band from the downlink frame, to search for an MTC downlink resource region in the downlink frame based on the information related to the MTC downlink band, and to extract MTC data for the corresponding MTC device from the MTC downlink resource region.

The MTC downlink band includes a band through which at least a physical broadcast channel and a synchronization signal are transmitted.

The controller may configure an uplink frame including an MTC uplink resource region based on the information related to the MTC uplink band, and the MTC uplink band may include at least one resource block located at a central part of an uplink system bandwidth.

The MTC device may further include a transmitter configured to transmit the uplink frame to the base station.

In another example embodiment, there is provided a downlink data transmission apparatus including: a machine type communication (MTC) controller configured to configure a downlink frame including information related to an MTC downlink band, and information related to an MTC uplink band; and a transceiver configured to transmit the downlink frame to at least one MTC device, and to receive MTC data from the at least one MTC device.

The MTC downlink band includes a band through which at least a physical broadcast channel and a synchronization signal are transmitted.

The downlink data transmission apparatus may further include an MTC information storage unit configured to store the information related to the MTC downlink band, and the information related to the MTC uplink band.

According to the embodiments as described above, it is possible to provide MTC service while maintaining compatibility with an existing mobile communication system.

Also, it is possible to provide efficient MTC service using limited radio resources.

### BRIEF DESCRIPTION OF DRAWINGS

Example embodiments of the present invention will become more apparent by describing in detail example embodiments of the present invention with reference to the accompanying drawings, in which:

FIG. 1 is a view for explaining the concept of a mobile communication network that provides machine type communication (MTC) service to which the present invention is applied;

FIG. 2 shows a structure of a downlink frame that is used in a mobile communication system to which the present invention can be applied;

FIG. 3 shows a structure of a downlink radio resource for supporting MTC, according to an embodiment of the present invention;

FIGS. 4 and 5 show structures of downlink radio resources including radio resource regions for supporting MTC, according to embodiments of the present invention;

FIGS. 6 through 9 show structures of uplink radio resources including radio resource regions for supporting MTC, according to embodiments of the present invention;

FIG. 10 is a block diagram of a base station according to an embodiment of the present invention;

FIG. 11 is a block diagram of an MTC device according to an embodiment of the present invention;

FIG. 12 is a flowchart illustrating a data transmission and reception method of an MTC device, according to an embodiment of the present invention; and

FIG. 13 is a flowchart illustrating a data transmission and reception method of an MTC device, according to another embodiment of the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “terminal” used in this specification may be referred to as a mobile station, User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

Also, in this specification, the term “cell” or “base station” means a fixed or movable point that communicates with terminals, and may be referred to as another word, such as a base station, Node-B, eNode-B, a base transceiver system (BTS), an access point, a relay, a femto-cell, etc.

Meanwhile, in this specification, in order to distinguish a terminal that is used for machine type communication (MTC) service from a terminal that is used mainly by a user, a terminal that is used for MTC service will be referred to as an “MTC device”, and a terminal for communication between users will be referred to as a “user terminal”. Also, the term “MTC device” will be used as a comprehensive term, such as an MTC terminal/device, a M2M terminal/device, etc., including various related terms, regardless of International Organization for Standardization.

Also, in this specification, the term “3GPP LTE system” can be interpreted as including a 3GPP LTE system and a 3GPP LTE Advanced system.

Hereinafter, embodiments of the present invention will be described in detail with reference to the appended drawings. In the following description, for easy understanding, like numbers refer to like elements throughout the description of the figures, and the same elements will not be described further.

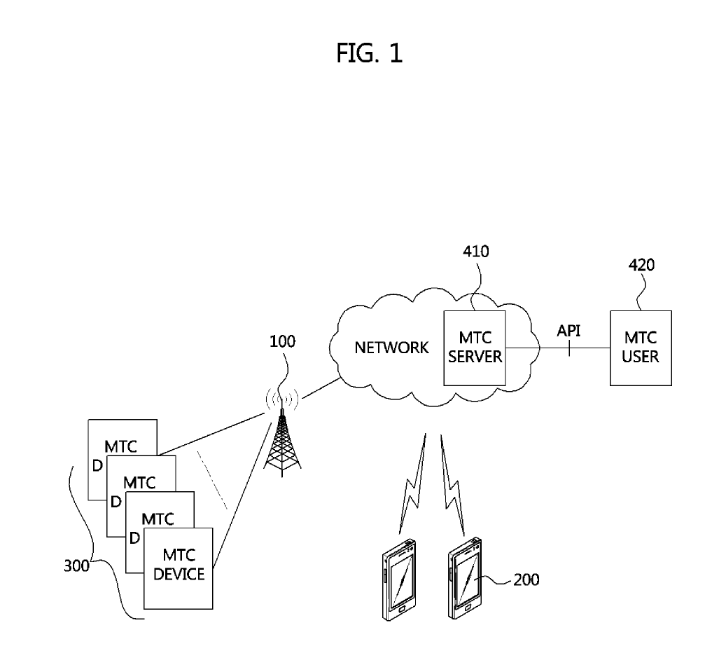

FIG. 1 is a view for explaining the concept of a mobile communication network that provides machine type communication (MTC) service to which the present invention is applied.

As shown in FIG. 1, the mobile communication network includes an MTC server 410 that provides MTC service, an MTC user 420, and at least one MTC device 300, in addition to a base station 100 and user terminals 200 which are components of a conventional mobile communication network.

Each MTC device 300 is a terminal having an MTC function for communicating with the MTC server 410 and other MTC devices through a public land mobile network (PLMN).

The MTC server 410 communicates with the MTC device 300 through the PLMN. The MTC server 410 has an interface that can be accessed by the MTC user 420, and provides service for the MTC user 420. The MTC user 420 uses the service that is provided by the MTC server 410.

In the configuration shown in FIG. 1, the MTC server 410 is controlled by a network operator, the network operator provides an application programming interface (API) on the MTC server 410, and the MTC user 420 accesses the MTC server 410 of the network operator through the API.

Meanwhile, FIG. 1 shows the case where the MTC server 410 is located in the network operator's domain, however, the MTC server 410 may be located out of the network operator's domain. If the MTC server 410 is located out of the network operator's domain, the MTC server 410 is not under the control of the network operator.

Also, the MTC device 300 communicates with the MTC server 410, etc. located in the network through the base station 100. It is expected that there are significantly more (for example, about 20 to 100 times) MTC devices 300 than the number of user terminals per unit service area, considered in a conventional mobile communication system.

It is assumed that the MTC device 300 transmits a small amount of data (about 150 through 200 bytes) at significantly long intervals or at aperiodic intervals (for example, at intervals of several seconds to dozens of days, or at packet generation intervals corresponding to several seconds to dozens of days).

In order to provide MTC service in a mobile communication network or in a wireless network, methods of efficiently allocating identifiers to MTC devices, of efficiently allocating resources, and of performing retransmission are needed. Also, efficient management and control for connection establishment between MTC devices and end nodes (for example, base stations) in a wireless network for packet transmission are required.

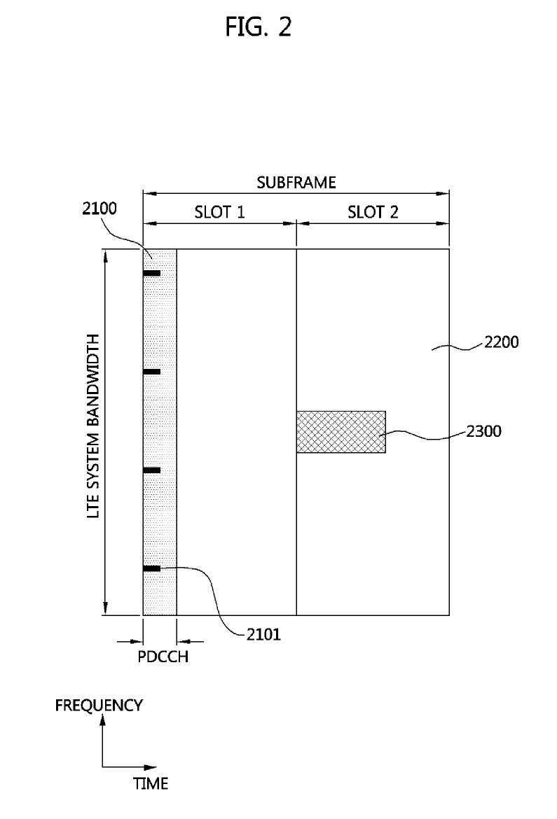

FIG. 2 shows a structure of a downlink frame that is used in a mobile communication system to which the present invention can be applied;

FIG. 2 shows representative channels that are used in a 3GPP LTE Release 8/9/10 standard which is a representative mobile communication system to which embodiments of the present invention can be preferably applied.

A physical downlink shared channel (PDSCH) 2200 transmits downlink data. A physical downlink control channel (PDCCH) 2100 transmits control information for demodulating the PDSCH 2200.

Also, a physical control format indicator channel (PCFICH) 2101 transmits the number of OFDM symbols occupied by the PDCCH 2100, and a physical broadcast channel (PBCH) 2300 transmits system information such as a system bandwidth, etc.

The PDCCH 2100 may be transmitted through an OFDM symbol region consisting of the first OFDM symbol, the first and second OFDM symbols, the first to third OFDM symbols, or the first to fourth OFDM symbols of each subframe.

That is, if the system bandwidth is narrower than or equal to 10 resource blocks (RBs), the PDCCH 2100 may be transmitted through an OFDM symbol region consisting of the first and second OFDM symbols, the first to third OFDM symbols, or the first to fourth OFDM symbols of each subframe.

Meanwhile, if the system bandwidth is wider than 10 RBs, the PDCCH 2100 may be transmitted through an OFDM symbol region consisting of the first OFDM symbol, the first and second OFDM symbols, or the first to third OFDM symbols of each subframe. Each resource block includes 12 subcarriers in a frequency domain.

Information about the number of OFDM symbols on which the PDCCH 2100 is transmitted is transmitted through the PCFICH 2101.

The PCFICH 2101 is, as shown in FIG. 2, included in the first OFDM symbol of each subframe. Hybrid-ARQ Acknowledge (HARQ-ACK) information is transmitted through a Physical Hybrid-ARQ Indicator Channel (PHICH), and the PHICH is transmitted through the same OFDM symbols through which the PDCCH 2100 is transmitted. In this case, the PDCCH 2100, the PCFICH 2101, and the PHICH are transmitted over the entire system bandwidth.

The present invention proposes methods in which an MTC device accesses a 3GPP LTE system based on the channel structure as described above, and operates.

There are various kinds of MTC devices including meters for measuring quantities of gas, electricity, etc., analysis instruments for health care, apparatuses for tracing locations of ships or vehicles, apparatuses for measuring environmental states (a level of air pollution, occurrence of fire, presence of a noxious substance, etc.), mobile payment apparatuses, apparatuses for checking the states of home appliances, etc.

When an MTC device accesses a 3GPP LTE system and operates, a downlink bandwidth of the MTC device may be set to be equal to or different from its uplink bandwidth.

When a plurality of MTC devices access a 3GPP LTE system and operate, all of the MTC devices may be set to have the same downlink bandwidth, or the MTC devices may be set to have different downlink bandwidths, respectively.

Also, when a plurality of MTC devices access a 3GPP LTE system and operate, all of the MTC devices may be set to have the same uplink bandwidth, or the MTC devices may be set to have different uplink bandwidths, respectively.

An MTC device is required to operate in a 3GPP LTE system and to be manufactured at low cost. In order to lower the manufacturing cost of an MTC device, the MTC device may be configured to have only a part of functions of a 3GPP LTE terminal.

Also, the MTC device may be configured to operate with a significantly narrower bandwidth than that provided by a 3GPP LTE cell to which the MTC device is connected. For example, a system bandwidth supported by a 3GPP LTE cell to which an MTC device is connected may be 10 MHz, and a bandwidth supported by the MTC device may be 1.4 MHz. In this case, the MTC device can receive signals with respect to 1.4 MHz which is a part of the system bandwidth of 10 MHz provided by the corresponding cell.

Meanwhile, since a PDCCH for a 3GPP LTE system is transmitted over 10 MHz, an MTC device may not properly decode a PDCCH, a PCFICH, and a PHICH that are provided by a 3GPP LTE cell.

In order to overcome this problem, it is necessary to newly configure a downlink physical control channel, a downlink physical control format indicator channel, a HARQ-ACK feedback channel, etc. for an MTC device.

For convenience of description, a downlink physical control channel, a downlink physical control format indicator channel, and a HARQ-ACK feedback channel for an MTC device are referred to as an MTC-PDCCH, an MTC-PCFICH, and an MTC-PHICH, respectively. That is, the MTC-PDCCH is a channel for transmitting control information about the MTC device, the MTC-PCFICH is a channel indicating the number of OFDM symbols for transmitting the MTC-PDCCH, and the MTC-PHICH is a channel for feeding back ACK/NACK information about an uplink data channel for the MTC device.

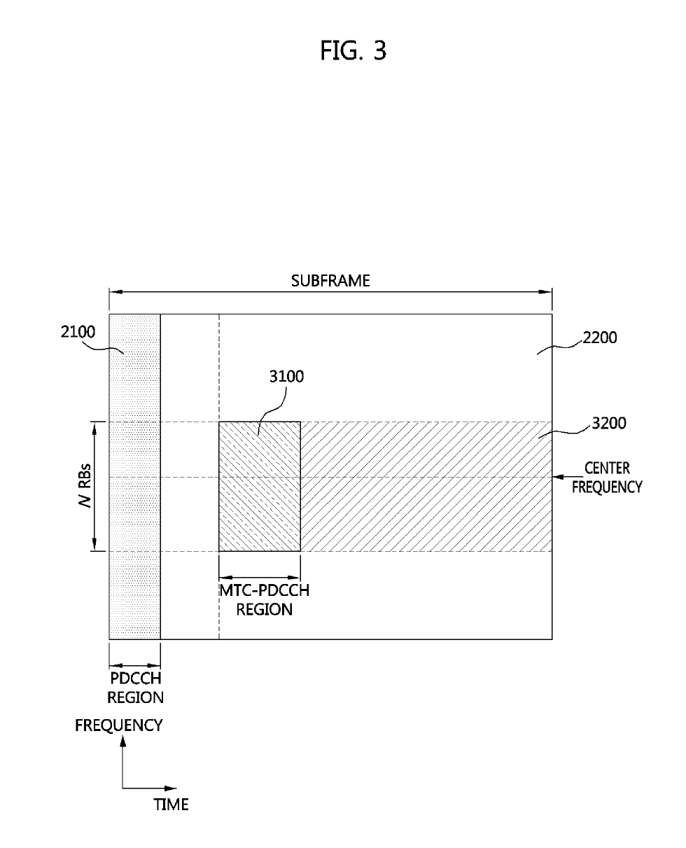

Hereinafter, a method of configuring an MTC-PDCCH, an MTC-PCFICH, and an MTC-PHICH for an MTC device will be described with reference to FIG. 3.

FIG. 3 shows a structure of a downlink radio resource for supporting MTC, according to an embodiment of the present invention.

First, a method of transmitting an MTC-PDCCH 3100 in a time domain is as follows. In order to avoid collision with a PDCCH 2100 for LTE terminals, the MTC-PDCCH 3100 is transmitted through OFDM symbols through which no PDCCH is transmitted. The location at which the MTC-PDCCH 3100 starts to be transmitted may be set by several methods which will be described below. In the following description, L represents the location of an OFDM symbol at which the MTC-PDCCH 3100 starts to be transmitted in a subframe.

A method of designating a location at which the MTC-PDCCH 3100 starts to be transmitted, according to an embodiment of the present invention, is to use a fixed location of L.

The current embodiment is a method of transmitting the MTC-PDCCH 3100 from a predetermined, fixed location. Preferably, a region through which the MTC-PDCCH 3100 is transmitted may be an OFDM symbol region in which no PDCCH is transmitted. More preferably, a region through which the MTC-PDCCH 3100 is transmitted may be an OFDM symbol region starting from a symbol following a symbol occupied by the PDCCH 2100.

The fixed location L is indicated by a predetermined value regardless of the bandwidth of a LTE system, or by a predetermined value depending on the LTE system bandwidth.

A method of differentiating the L value according to the bandwidth of a 3GPP LTE system is as follows. If the bandwidth of a 3GPP LTE system is narrower than or equal to 10 RBs, the L value may be set to indicate the fifth OFDM symbol of a subframe, and if the bandwidth of a 3GPP LTE system is wider than 10 RBs, the L value may be set to indicate the fourth OFDM symbol of a subframe. The reason is because a PDCCH can be transmitted through a maximum of four OFDM symbols if the bandwidth of a 3GPP LTE system is narrower than or equal to 10 RBs, and a PDCCH can be transmitted through a maximum of three OFDM symbols if the bandwidth of the 3GPP LTE system is wider than 10 RBs.

A method of using a fixed L value regardless of the bandwidth of a 3GPP LTE system is to set the L value to a value indicating the fifth OFDM symbol of a subframe.

The reason for setting a value indicating the start location of an MTC-PDCCH to a predetermined, fixed value is because information about the number of symbols through which a PDCCH is transmitted is transmitted through a PCFICH, and an MTC device may not be able to decode the PCFICH due to a difference between a bandwidth which the MTC device uses and a bandwidth which the system uses.

That is, one of methods of allowing an MTC device to detect the start location of an MTC-PDCCH without receiving information of a PCFICH is to designate a value indicating the start location of an MTC-PDCCH to a predetermined, fixed value.

Another embodiment related to the start location of an MTC-PDCCH is a method of allowing an MTC device to receive information about the start location L of an MTC-PDCCH from a LTE system.

An embodiment for implementing the method is a method in which a 3GPP LTE system includes information about the start location of an MTC-PDCCH in a physical broadcasting channel (PBCH), and transmits the PBCH. An MTC device decodes the PBCH transmitted from the LTE system to thereby acquire the information about the start location of the MTC-PDCCH.

If the bandwidth of a 3GPP LTE system is the same as the bandwidth of an MTC device, an existing PDCCH can be used as an MTC-PDCCH. In this case, an existing PCFICH can be used as an MTC-PCFICH, an existing PHICH can be used as an MTC-PHICH, and also, an existing 3GPP LTE method can be used as a data transmission and reception method of the MTC device.

A downlink bandwidth for MTC devices may be designated as a predetermined value defined in the specification. Alternatively, an MTC device may acquire information about a downlink bandwidth for MTC by receiving a PBCH. In this case, the PBCH includes information about a downlink bandwidth for MTC as well as information about a bandwidth of a 3GPP LTE system. For example, the PBCH may include information indicating the number of RBs that are used for downlink transmission for MTC.

If the bandwidth of the MTC device is narrower than the bandwidth of the 3GPP LTE system, an MTC-PDCCH is transmitted through only a part of the bandwidth of the 3GPP LTE system.

A method of transmitting an MTC-PDCCH in a frequency domain, according to an embodiment of the present invention, is to transmit the MTC-PDCCH using a fixed bandwidth which is located at a central part of the 3GPP LTE system bandwidth.

FIG. 3 shows an MTC-PDCCH transmission method according to an embodiment of the present invention. As shown in FIG. 3, the MTC-PDCCH is transmitted using a frequency band corresponding to N RBs located in the central part of the 3GPP LTE system bandwidth.

According to an embodiment, the MTC-PDCCH is transmitted using the same bandwidth through which a PBCH and a synchronization signal are transmitted. That is, the MTC-PDCCH is transmitted using a frequency band corresponding to 6 RBs located in the central part of the system bandwidth.

Here, a RB may be configured to include 12 subcarriers. In order for an MTC device to receive a synchronization signal and a PBCH and detect them, the bandwidth for MTC includes at least 6 RBs located in the central part of the system bandwidth.

Accordingly, the bandwidth for MTC is at least 6 RBs. Here, the bandwidth corresponding to the N RBs may be the same as or narrower than a downlink bandwidth for an MTC device.

That is, if all MTC devices accessing a 3GPP LTE system are set to have the same downlink bandwidth, the N RBs may be set to the same bandwidth as a system bandwidth for the MTC devices. Meanwhile, if MTC devices accessing a 3GPP LTE system are set to have different downlink bandwidths, respectively, the N RBs may be set to a bandwidth that is narrower than a downlink bandwidth for an MTC device.

The structure of an MTC-PDCCH may be based on the structure and configuration of a PDCCH of an existing 3GPP LTE Release 8/9/10 system whose system bandwidth is the same as a bandwidth through which the MTC-PDCCH is transmitted.

For example, if an MTC-PDCCH is transmitted using a bandwidth of 1.4 MHz, the MTC-PDCCH may have the same structure and configuration as those of a PDCCH with respect to a system bandwidth of 1.4 MHz in system bandwidths that are supported by the 3GPP LTE Release 8/9/10 system.

That is, a PDCCH format, a PDCCH multiplexing method for individual terminals, a scrambling method, a modulation method, a layer mapping method, a precoding method, a mapping-to-resource elements (REs) method, etc., which have been used for a PDCCH in the 3GPP LTE Release 8/9/10 system, may be used to configure an MTC-PDCCH.

A difference between the existing system and the present invention is in that a PDCCH is transmitted from the first OFDM symbol of a subframe, whereas an MTC-PDCCH is transmitted from the L-th symbol of a subframe.

Meanwhile, an MTC-PDSCH search space region for each MTC device may be set by a method for setting a PDCCH search space region for a 3GPP LTE terminal. Alternatively, in order to reduce the number of blind decoding operations, an MTC-PDSCH search space region may be set to a part of a region in which an MTC-PDCCH can exist.

Also, an aggregation level for an MTC-PDCCH may support, like a PDCCH, all of aggregation levels 1, 2, 4, and 8 that are represented as the numbers of Control Channel Elements (CCEs), or support a part of the aggregation levels 1, 2, 4, and 8 in order to reduce the number of blind decoding operations for the MTC-PDCCH.

Also, an MTC-PDCCH may be configured to be generated in subframes decided in a time domain, not in all subframes. That is, a PDCCH may be generated in all subframes, but an MTC-PDCCH is generated only in predetermined subframes at regular time intervals. Subframes that transmit MTC-PDCCHs may be decided by a predetermined period and a predetermined offset. That is, MTC-PDCCHs may be generated in only subframes corresponding to a predetermined period and a predetermined offset.

Here, the predetermined period and the predetermined offset may be set in a unit of subframe, and a 3GPP LTE cell may inform an MTC device of information about the predetermined period and the predetermined offset through signaling. Accordingly, the MTC device searches for an MTC-PDCCH related to itself in only subframes corresponding to the predetermined period and the predetermined offset.

A signaling method for information about a period and an offset in which an MTC-PDCCH is transmitted may include a semi-static method through RRC signaling, a dynamic method using MTC-downlink control information (MTC-DCI) that is transmitted through an MTC-PDCCH, etc. The RRC signaling may be signaling based on a RRC signaling method of an MTC device, or signaling based on a system information block (SIB).

In a 3GPP LTE system, additional system information (a system information block, etc.) other than system information that is transmitted through a PBCH is transmitted through a PDSCH region. However, since the downlink bandwidth of an MTC device is narrower than the bandwidth of a 3GPP LTE terminal, a case where the MTC device cannot receive a PDSCH including additional system information may be generated. In order to overcome this problem, according to an embodiment of the present invention, a PDSCH including system information may be transmitted through N RBs (that is, N RBs corresponding to a central part of a 3GPP LTE system bandwidth) that transmits an MTC-PDCCH for MTC devices.

Data about an MTC device is transmitted using a frequency band corresponding to Y RBs that are a central part of the 3GPP LTE system bandwidth. A bandwidth corresponding to the Y RBs includes a bandwidth through which an MTC-PDCCH is transmitted. That is, a bandwidth corresponding to the Y RBs may be the same as or wider than a bandwidth through which an MTC-PDCCH is transmitted.

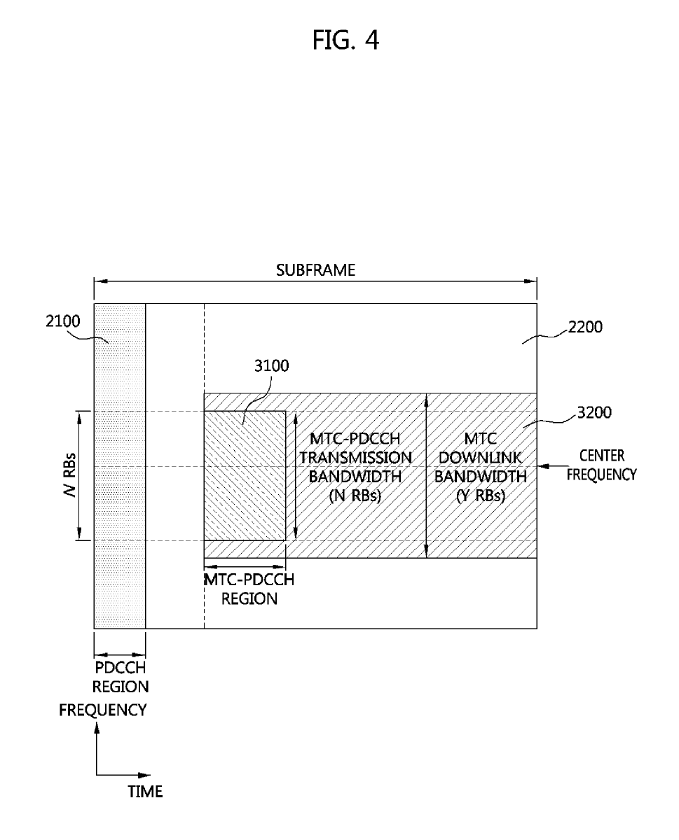

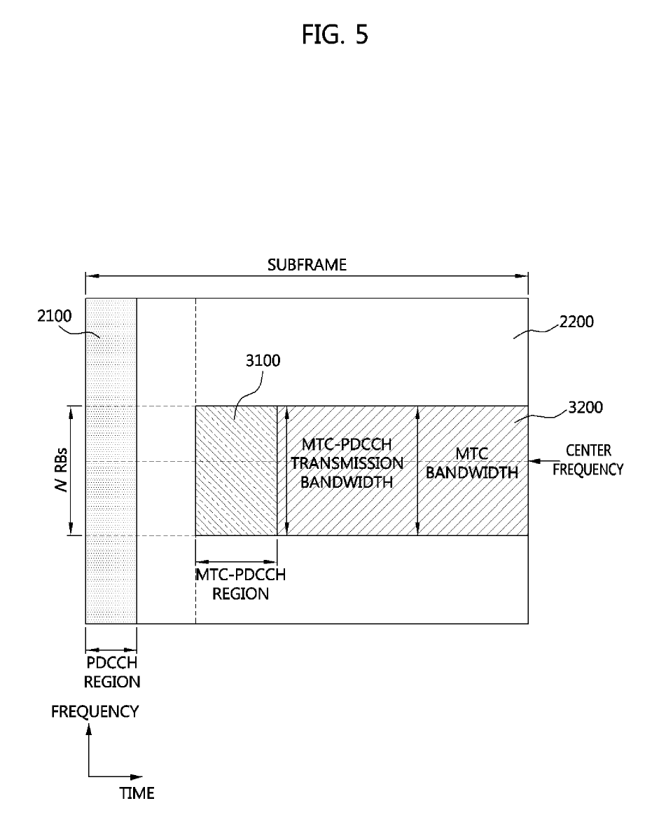

FIGS. 4 and 5 show structures of downlink radio resources including radio resource regions for supporting MTC, according to embodiments of the present invention.

A downlink transmission bandwidth for an MTC device is the same as or wider than a bandwidth through which an MTC-PDCCH for an MTC device is transmitted.

FIG. 4 shows the case where a downlink transmission bandwidth (consisting of Y RBs) of an MTC device is different from a bandwidth (consisting of N RBs) through which an MTC-PDCCH is transmitted, and FIG. 5 shows the case where a downlink transmission bandwidth of an MTC device is the same as a bandwidth through which an MTC-PDCCH is transmitted.

As shown in FIG. 4, the downlink transmission bandwidth of the MTC device includes the bandwidth through which the MTC-PDCCH is transmitted. That is, for example, the MTC-PDCCH may be transmitted through a bandwidth of 1.4 MHz, and the downlink bandwidth of the MTC device may be 5 MHz. That is, the bandwidth of 5 MHz includes the bandwidth of 1.4 MHz.

Even when MTC devices accessing a 3GPP LTE system are set to be allocated different downlink bandwidths, respectively, the bandwidth on which the MTC-PDCCH for each MTC device is transmitted is set to be the same. That is, in the embodiments of FIGS. 4 and 5, all MTC devices use the same N value.

Another configuration method for an MTC-PDCCH is to use a configuration method for an Enhanced PDCCH (E-PDCCH or ePDCCH) which is a control channel based on a Demodulation Reference Signal (DM-RS) that is transmitted through a PDSCH.

Here, E-PDCCH or ePDCCH means a control channel that is transmitted through a resource region through which a PDSCH is transmitted in a 3GPP LTE system. The physical control channel may be transmitted by applying the same precoding as that applied to a DM-RS existing in a frequency band corresponding to RBs through which the physical control channel is transmitted. The E-PDCCH or ePDCCH, which is a control channel that is applied to a 3GPP LTE Release 11 or Release 12, is transmitted through a PDSCH region.

An E-PDCCH including control information for MTC devices is transmitted using the entire or a part of a frequency band corresponding to centered N RBs of a 3GPP LTE downlink system bandwidth. According to an embodiment of using a fixed bandwidth corresponding to N RBs, the fixed bandwidth may be the same bandwidth through which a PBCH and a synchronization signal are transmitted.

The number of OFDM symbols through which an MTC-PDCCH is transmitted may be fixed to a predetermined value, or may be informed through an MTC-PCFICH.

In the case of informing MTC devices of the number of OFDM symbols through which an MTC-PDCCH is transmitted using an MTC-PCFICH, the MTC-PCFICH is transmitted through the first OFDM symbol through which an MTC-PDCCH is transmitted. That is, if an MTC-PDCCH is transmitted from a k-th OFDM symbol, an MTC-PCFICH is transmitted through the k-th OFDM symbol.

The MTC-PHICH may be transmitted through all or a part of OFDM symbols through which the MTC-PDCCH is transmitted. That is, if the MTC-PDCCH is transmitted through k-th, (k+1)-th, (k+2)-th, . . . , (k+M)-th OFDM symbols, the MTC-PHICH may also be transmitted through the k-th, (k+1)-th, (k+2)-th, . . . , N-th OFDM symbols, wherein N is smaller than or equal to k+M. Information about the number of OFDM symbols used to transmit the MTC-PHICH may be transmitted through a PBCH.

MTC-PHICHs mapped to the same time-frequency resource are referred to as an MTC-PHICH group. That is, MTC-PHICHs belonging to the same group are mapped to the same time-frequency resource, and MTC-PHICHs belonging to different groups are mapped to different frequency resources.

Information about the number of MTC-PHICH groups may be transmitted through a PBCH.

Different MTC-PHICHs may be distinguished by different MTC-PHICH indices. In order to decide an MTC-PITCH for transmitting ACK/NACK information in response to a physical uplink shared channel (PUSCH) from each MTC device, a rule applied to a PUSCH and PHICH of a 3GPP LTE system may be used as is.

In other words, an index value of an MTC-PHICH may be decided by a lowest uplink resource block index configuring a PUSCH for an MTC device and a cyclic shift value of an uplink demodulation reference signal, and then mapped to a radio resource (for example, a resource element (RE)).

A band and bandwidth through which the MTC-PCFICH is transmitted may be the same band and bandwidth through which the MTC-PDCCH is transmitted.

Also, a band and bandwidth through which the MTC-PHICH is transmitted may be the same band and bandwidth through which the MTC-PDCCH is transmitted.

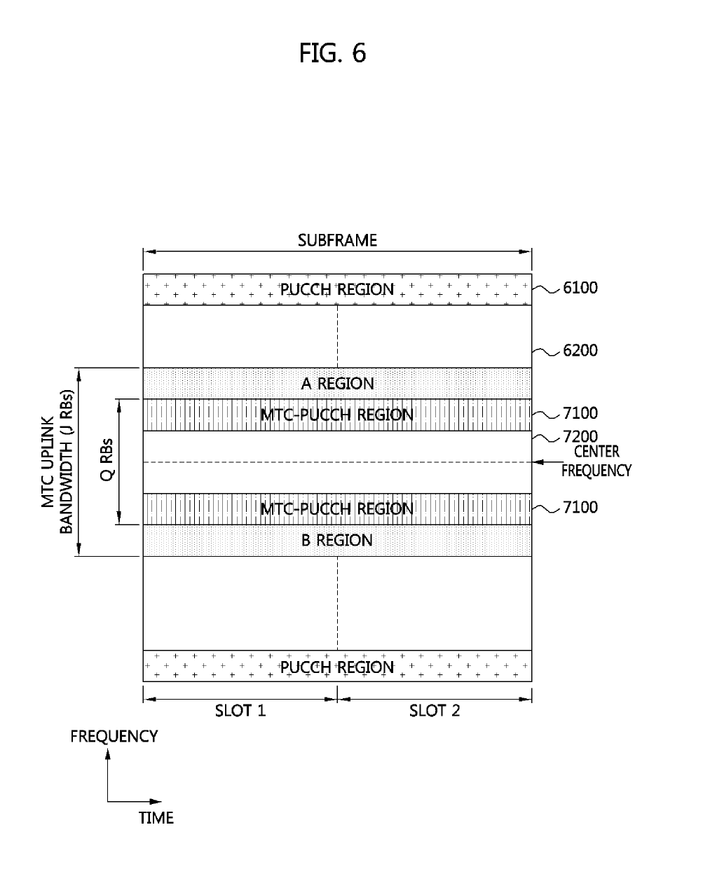

Hereinafter, an uplink radio resource structure will be described with reference to FIGS. 6 through 9.

FIGS. 6 through 9 show structures of uplink radio resources including radio resource regions for supporting MTC, according to embodiments of the present invention;

An uplink transmission bandwidth for an MTC device may be the same as or different from a downlink transmission bandwidth for an MTC device. Here, the uplink transmission bandwidth for an MTC device may correspond to J successive RBs in the uplink system bandwidth of the 3GPP LTE Release 8/9/10. The J successive RBs for MTC may be J RBs corresponding to the central part of the uplink system bandwidth. Also, the J successive RBs for MTC may be located at an arbitrary location in the uplink system bandwidth.

In order to allow an MTC device to perform random access, etc. using an existing physical random access channel (PRACH), an uplink transmission bandwidth for MTC according to an embodiment of the present invention may include 6 RBs on which PRACH is transmitted In this case, the uplink transmission bandwidth for MTC may be 6 RBs or more.

According to another embodiment, an MTC device may use a newly defined random access channel for MTC devices and use it, without using an existing PRACH. In this case, the newly defined random access channel for MTC devices may be transmitted using arbitrary uplink frequency bands regardless of the uplink frequency band used for the existing PRACH.

In this specification, an uplink control channel for an MTC device is, for convenience of description, referred to as an MTC-PUCCH. The MTC-PUCCH is configured to include one or more RBs located at both ends of Q successive RBs in a 3GPP LTE uplink bandwidth. Here, the Q value is equal to or smaller than the J value which is the number of resource blocks corresponding to an MTC uplink bandwidth.

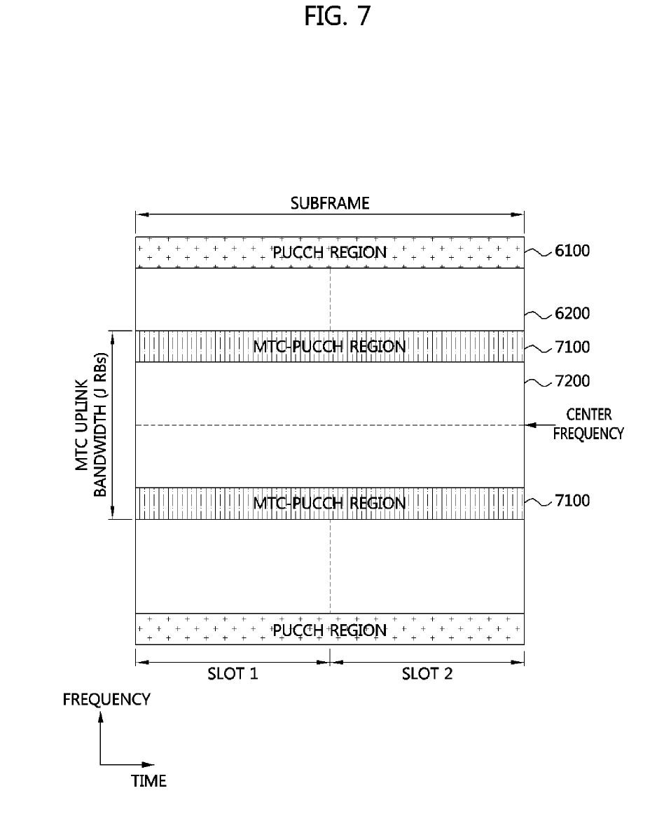

FIGS. 6 and 7 show the case where Q RBs exist in the central part of the 3GPP LTE uplink bandwidth.

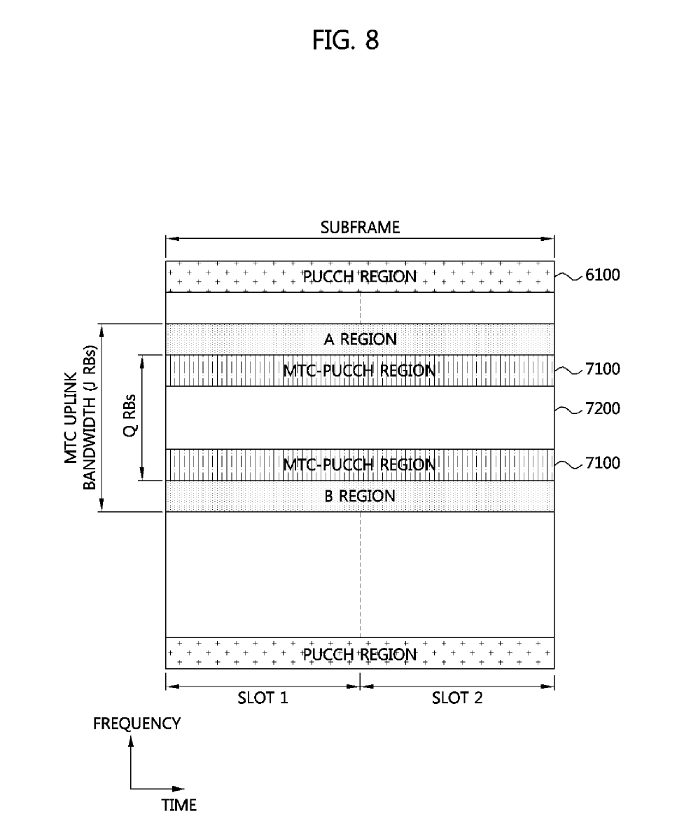

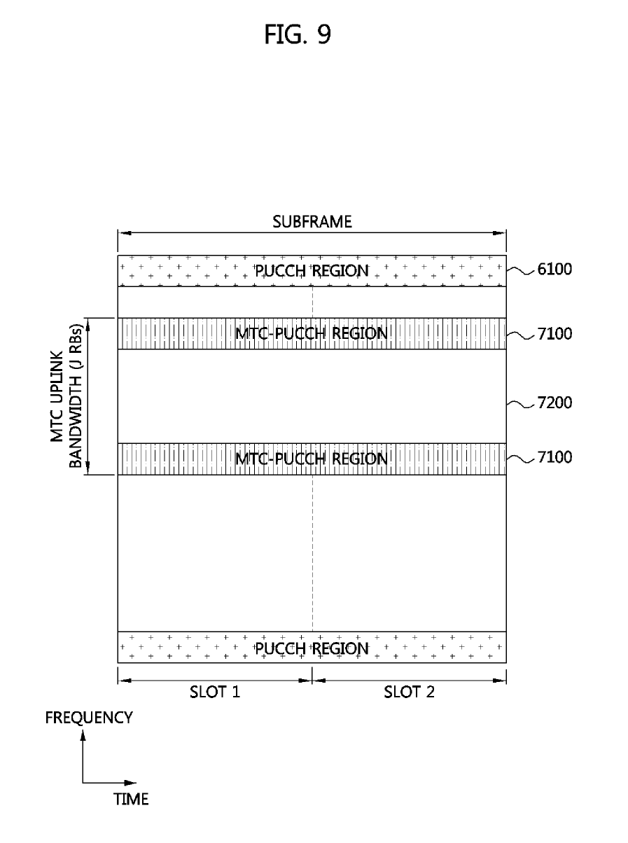

FIGS. 8 and 9 show the case where Q RBs exist at an arbitrary location in the 3GPP LTE uplink bandwidth.

FIGS. 6 and 8 correspond to the case where the Q value is smaller than the J value, and FIGS. 7 and 9 correspond to the case where the Q value is equal to the J value.

As shown in FIGS. 6 and 8, if the Q value is smaller than the J value, uplink data may be transmitted from an MTC device to a base station through A and B regions. As shown in FIGS. 7 and 9, if the Q value is equal to the J value, there are no A and B regions.

According to an embodiment, the Q value related to the location from which an MTC-PUCCH is transmitted may be a fixed value. That is, even when MTC devices have different MTC uplink bandwidths (that is, different J values), a Q value related to frequencies corresponding to both ends of a bandwidth through which an MTC-PUCCH is transmitted, and RB indices corresponding to both ends of the bandwidth through which the MTU-PUCCH is transmitted may be the same values with respect to all of the MTC devices.

The MTC-PUCCH may have the same structure as a PUCCH, and may be transmitted by the same method as a method of transmitting a PUCCH. That is, a PUCCH format, a physical resource mapping method, an orthogonal coding setting method for PUCCH, a reference signal transmission method, etc., which have been used for a PUCCH, may be applied to an MTC-PUCCH.

By allocating different MTC-PUCCH indices to different MTC-PUCCHs, the different MTC-PUCCH may be distinguished from one another. An MTC-PUCCH index which will be used by an MTC UE to transmit an ACK/NACK message, a Precoding Matrix Index/Rank Index (PMI/RI) message, and a Channel Quality Indicator (CQI) may be decided using a rule applied to a 3GPP LTE system. In other words, an MTC-PUCCH index to be used by an MTC device is decided by the lowest CCE index value of an MTC-PUCCH for the corresponding MTC device, and then mapped to a radio resource (for example, a RE).

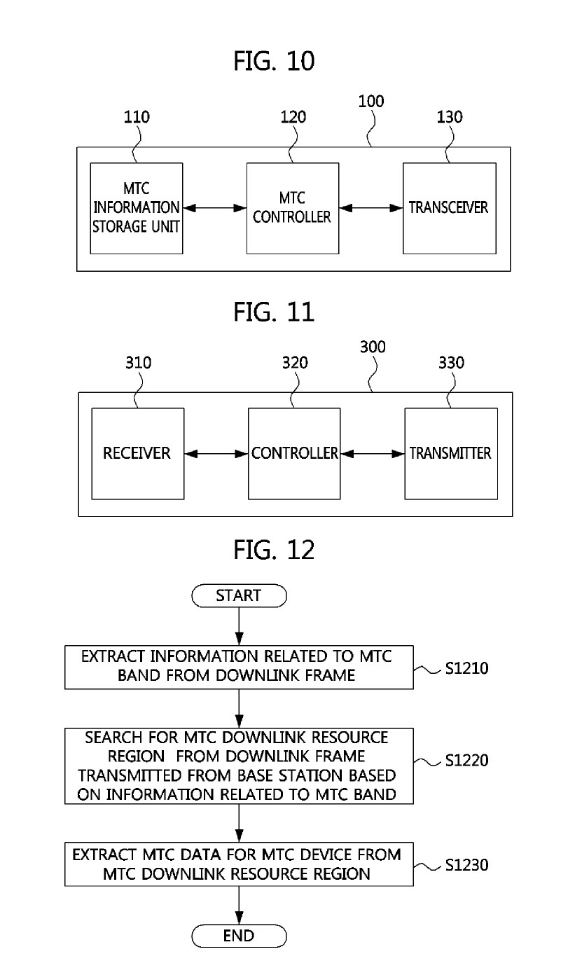

FIG. 10 is a block diagram of a base station 100 according to an embodiment of the present invention.

Referring to FIG. 10, the base station 100 may be configured to include an MTC information storage unit 110, an MTC controller 120, and a transceiver 130.

The MTC information storage unit 110 stores various information required to provide MTC service. For example, the MTC information storage unit 110 may store information related to an MTC downlink band, and information related to an MTC uplink band.

The MTC controller 120 configures a downlink frame including the information related to the MTC downlink band and the information related to the MTC uplink band stored in the MTC information storage unit 110.

The MTC downlink band may include a band through which at least a physical broadcast channel and a synchronization signal are transmitted.

Also, the transceiver 130 transmits the downlink frame configured by the MTC controller 120, and receives signals and data transmitted from at least one MTC device.

FIG. 11 is a block diagram of an MTC device 300 according to an embodiment of the present invention.

Referring to FIG. 11, the MTC device 300 may be configured to include a receiver 310, a controller 320, and a transmitter 330.

The receiver 310 receives a downlink frame from a base station. The controller 320 extracts information related to an MTC downlink band from the downlink frame, and searches for an MTC downlink resource region in the downlink frame based on the information related to the MTC downlink band to extract MTC data for the corresponding MTC device.

Here, the MTC downlink band may include a band through which at least a physical broadcast channel and a synchronization signal are transmitted.

The controller 320 may also extract information related to an MTC uplink band from the downlink frame received from the base station, and configure an uplink frame including an MTC uplink resource region including an MTC uplink resource region based on the information related to the MTC uplink band. The transmitter 330 functions to transmit the uplink frame to the base station. Here, the MTC uplink band may include at least one resource block located at the central part of an uplink system bandwidth.

FIG. 12 is a flowchart illustrating a data transmission and reception method of an MTC device, according to an embodiment of the present invention.

If the MTC device receives a downlink frame from a base station, the MTC device extracts information related to an MTC band from the downlink frame (S1210). Here, the information related to the MTC band may include information related to an MTC downlink band, and information related to an MTC uplink band.

Then, the MTC device searches for an MTC downlink resource region in the downlink frame transmitted from the base station, based on the information related to the MTC band (S1220). Next, the MTC device extracts MTC data for the corresponding MTC device from the MTC downlink resource region (S1230).

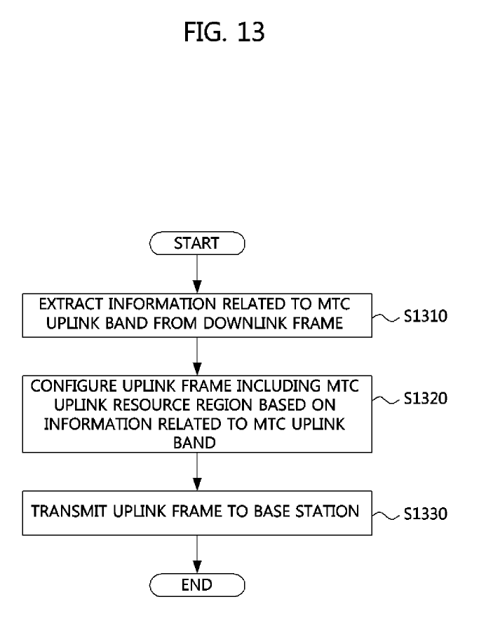

FIG. 13 is a flowchart illustrating a data transmission and reception method of an MTC device, according to another embodiment of the present invention.

If the MTC device receives a downlink frame from a base station, the MTC device extracts information related to an MTC uplink band from the downlink frame (S1310).

Then, the MTC device configures an uplink frame including an MTC uplink resource region based on the information related to the MTC uplink band (S1320). The configured uplink frame is transmitted to the base station (S1330).

Operations for transmission of MTC downlink and uplink data have been described with reference to FIGS. 12 and 13, respectively, however, it is also possible that operations described above with reference to FIG. 13 are performed just after operations described above with reference to FIG. 12. Also, if the locations of MTC downlink and uplink bandwidths and bands are fixed, operations of extracting the information related to the MTC band, as described above with reference to FIGS. 12 and 13, may be omitted.

While the example embodiments of the present invention and their advantages have been described in detail, it should be understood that various changes, substitutions and alterations may be made herein without departing from the scope of the invention.

What is claimed is:

1. A data transmission and reception method of a machine type communication (MTC) device, comprising:
extracting information related to an MTC band from a downlink frame received from a base station;
searching for an MTC downlink resource region in the downlink frame based on the information related to a MTC downlink band; and
extracting MTC data for the corresponding MTC device from the MTC downlink resource region,
wherein the MTC downlink band includes a band through which at least a physical broadcast channel and a synchronization channel are transmitted.

2. The data transmission and reception method of claim 1, wherein the information related to the MTC downlink band includes at least one piece of information among information about an MTC downlink bandwidth, information about the location of an MTC downlink band, information about an MTC downlink control channel, and information about an MTC downlink data channel.

3. The data transmission and reception method of claim 1, wherein the MTC downlink resource region includes an MTC downlink control channel and an MTC downlink data channel.

4. The data transmission and reception method of claim 3, wherein the MTC downlink resource region includes at least one piece of information of information about the number of symbols occupied by the MTC downlink control channel, and information about an MTC retransmission indicator.

5. The data transmission and reception method of claim 1, wherein the MTC downlink band includes at least one resource block located at a central part of a downlink system bandwidth.

6. A data transmission and reception method of a machine type communication (MTC) device, comprising:
extracting information related to an MTC uplink band from a downlink frame received from a base station;
configuring an uplink frame including an MTC uplink resource region based on the information related to the MTC uplink band; and
transmitting the uplink frame to the base station,
wherein the MTC uplink band includes at least one resource block on which physical random access channel (PRACH) is transmitted.

7. The data transmission and reception method of claim 6, wherein the information related to the MTC uplink band includes at least one piece of information among information about an MTC uplink bandwidth, information about the location of an MTC uplink band, information about an MTC uplink control channel, and information about an MTC uplink data channel.

8. The data transmission and reception method of claim 6, wherein the MTC uplink bandwidth is the same as or narrower than an uplink system bandwidth.

9. A downlink data transmission method comprising:
configuring a downlink frame including information related to a machine type communication (MTC) downlink band and information related to an MTC uplink band; and
transmitting the downlink frame to at least one MTC device,
wherein the MTC downlink band includes a band through which at least a physical broadcast channel and a synchronization signal are transmitted.

10. The downlink data transmission method of claim 9, wherein the MTC uplink band includes at least one resource block located at a central part of an uplink system bandwidth.

11. A machine type communication (MTC) device comprising:
a receiver configured to receive a downlink frame from a base station; and
a controller configured to extract information related to an MTC downlink band and information related to an MTC uplink band from the downlink frame, to search for an MTC downlink resource region in the downlink frame based on the information related to the MTC downlink band, and to extract MTC data for the corresponding MTC device from the MTC downlink resource region,
wherein the MTC downlink band includes a band through which at least a physical broadcast channel and a synchronization signal are transmitted.

12. The MTC device of claim 11, wherein the controller configures an uplink frame including an MTC uplink resource region based on the information related to the MTC uplink band, and
the MTC uplink band includes at least one resource block on which physical random access channel (PRACH) is transmitted.

13. The MTC device of claim 12, further comprising a transmitter configured to transmit the uplink frame to the base station.

14. A downlink data transmission apparatus comprising:
a machine type communication (MTC) controller configured to configure a downlink frame including information related to an MTC downlink band and information related to an MTC uplink band; and
a transceiver configured to transmit the downlink frame to at least one MTC device, and to receive MTC data from the at least one MTC device,
wherein the MTC downlink band includes a band through which at least a physical broadcast channel and a synchronization signal are transmitted.

15. The downlink data transmission apparatus of claim 14, further comprising an MTC information storage unit configured to store the information related to the MTC downlink band and the information related to the MTC uplink band.
